(19) United States
(12) Patent Application Publication
(10) Pub. No.: US 2019/0093405 A1
(43) Pub. Date: Mar. 28, 2019

(54) Dual-Opening Cabinet Door

(71) Applicant: Steven Cohen, Northlake, TX (US)

(72) Inventor: Steven Cohen, Northlake, TX (US)

(21) Appl. No.: 16/138,996

(22) Filed: Sep. 22, 2018

Related U.S. Application Data
(60) Provisional application No. 62/561,707, filed on Sep. 22, 2017.

(51) Int. Cl. E05D 15/04; E05D 3/06

(52) U.S. Cl. CPC E05D 15/04; E05Y 2900/20; E05D 3/06

(57) ABSTRACT

A system and method for a dual-opening cabinet door. The system includes a double-hinge. The system includes at least a first arm coupled to a first connecting hinge. The first arm is coupled to an additional hinge. The first connecting hinge is releasably connected to a support hinge to allow a cabinet door to open from either side.

### PRIORITY

The present invention claims priority to provisional application No. 62/561,707, filed Sep. 22, 2017, the entirety of which is hereby incorporated by reference.

### BACKGROUND OF THE INVENTION

### Technical Field

The present invention relates to a system and method for a dual-opening cabinet door.

### Description of Related Art

Typically, cabinet doors have one hinge located as the base of the door. The door swings about the hinge in a single direction. If the hinge is on the left of the door then the door can only open outward and leftward. Consequently, there is a need to have a door which can open from both sides.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a cabinet with a dual-opening door in one embodiment;

FIG. 2 is a perspective view of a cabinet with a dual-opening door in one embodiment and an example double-hinge in one embodiment;

FIG. 3 is a perspective view of double-hinges in various states in one embodiment;

FIG. 4 is a perspective view of a double-hinge in one embodiment;

FIG. 5 is a perspective view of a double-hinge in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

Previously, cabinet doors could only open in one direction. If there are only two cabinet doors, then the user would typically assume that the left door opens to the left and the right door opens on the right. However, that is not always the case. Further, some cabinets comprise three or more doors. In those situations, the middle door, for example, is a wild card and could open from either side. Especially for cabinet doors which do not comprise handles, the user has a 50% chance of attempting to open the door in the wrong direction. Thus, traditional cabinets often left the user guessing as to which direction the door would open.

Taken further, even if the user knew which direction a door opened, that direction is often not the optimal direction. Consider a cabinet which is adjacent to a dishwasher. If the left door only opened leftward then it could interfere with the operation of the dishwasher. The same is true if the left cabinet door is adjacent to a refrigerator door. If such scenarios, if the refrigerator door is open then that cabinet is inaccessible. Thus, many problems and inefficiencies result when a cabinet door only opens in a single direction. Applicant has provided a novel system and method which overcomes these deficiencies.

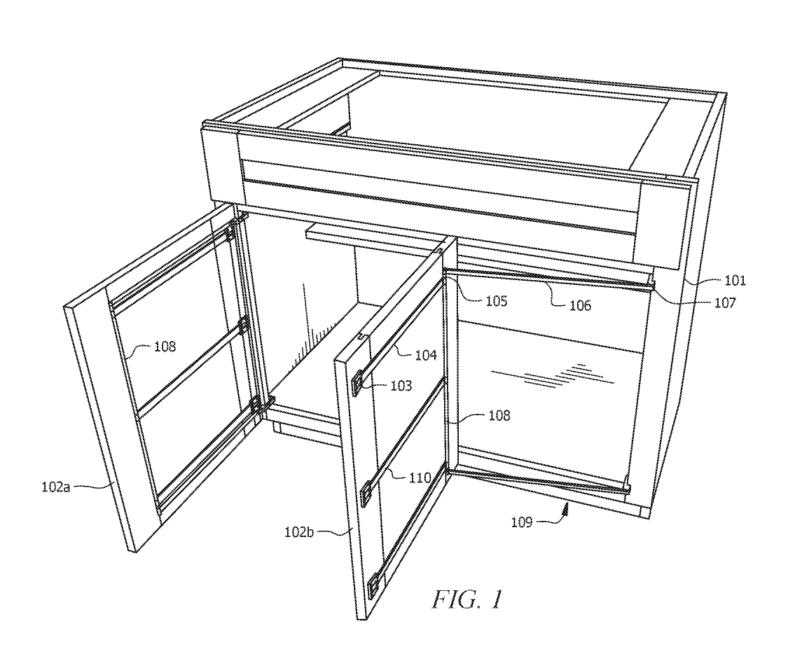

FIG. 1 is a perspective view of a cabinet with a dual-opening door in one embodiment. A dual-opening door, as used herein, refers to a door which can open in more than one direction from two opposing hinge points. A typical door has a hinge, or multiple hinges, but they are located on the same edge of the door. Such a door can only pivot about a single edge. Conversely, a dual-opening door comprises two opposing hinges and, accordingly, two opposing pivot points. In this manner, a door can swing from a first pivot point and a second pivot point. This allows a cabinet door, for example, to open leftward and rightward.

The cabinet 101 can comprise any type of cabinet including a kitchen cabinet, an entertainment cabinet, etc. A cabinet is any storage unit which comprises at least one door. The cabinet can comprise wood, plastic, metal, rubber, and combinations thereof.

The cabinet 101 comprises at least one door 102. The door 102 can comprise the same or different material as the cabinet 101. In one embodiment the door 102 is largely planar. The door comprises an outer side which is visible when the door is closed and an inner side which faces the interior cavity of the cabinet.

As noted, in one embodiment one or more doors comprise dual-opening doors and accordingly each have two opposing pivot points. As depicted, the cabinet 101 comprises two doors: a left door 102a and a right door 102b. As depicted, each of the doors 102 comprises two pivot points located on opposing sides.

Turning to the right door 102b, the right door is depicted as open in the leftward direction. Thus, the right door 102b has pivoted on its left pivot point.

Each door 102 comprises at least one double-hinge 109. As used herein, a double-hinge 109 is a device which features two hinges. In the double-hinge 109 depicted in FIG. 1, a first distal hinge 107 is located at a distal end and a second connecting hinge 105 connects two arms.

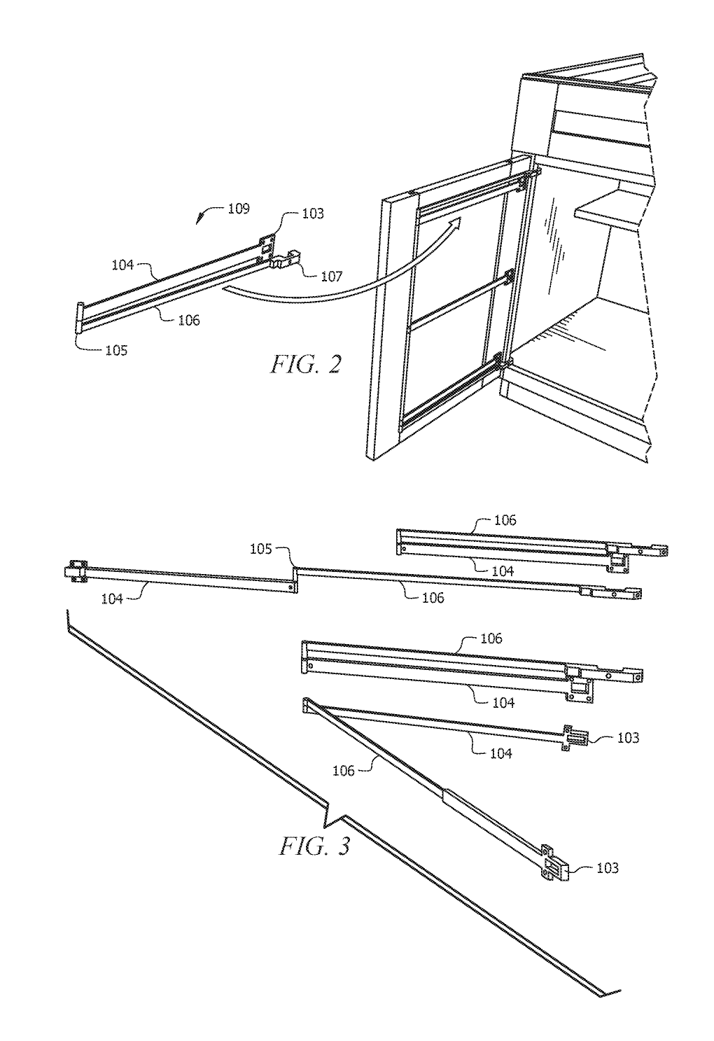

Turning briefly to FIG. 2, FIG. 2 is a perspective view of a cabinet with a dual-opening door in one embodiment and an example double-hinge in one embodiment. The hinge in FIG. 2 is in its retracted position. In the retracted position the two arms 104, 106 are adjacent to one another.

As depicted, the first arm 104 is coupled to the connecting hinge 105 and the coupler 103. The connecting hinge 105 can comprise virtually any hinge known in the art. In one embodiment the connecting hinge 105 is spring biased so that it urges the double-spring 109 into a retracted position. While a spring is described, this is for illustrative purposes only. Any mechanism, inherent or external, which provides biasing can be utilized. In one embodiment the connecting hinge 105 comprises internal resistance which results in a slowing of the opening and closing. Such a feature softens the closing of cabinet doors 102 and prevents slamming.

The first arm 104 couples to the connecting hinge 105 as does the second arm 106. In one embodiment, and as depicted, the two arms are connected to the connecting hinge 105 at a vertically offset location. As depicted, the first arm 104 is connected to a top portion of the connecting hinge 105 whereas the second arm 106 is connected to a lower portion of the connecting hinge 105.

The coupler 103 couples the double-hinge 109 to a cabinet door. In one embodiment the coupler 103 is similar to the existing brackets which couple the cabinet door to the hinge. In one embodiment the door 102 comprises a recess which can receive the coupler 103. The coupler 103 can be attached to the door via any method or device known in the art including screws, nails, bolts, etc.

The second arm 106 is coupled to the connecting hinge 105 and the distal hinge 107. As can be seen, the first arm 104 and the second arm 106 can pivot about the connecting hinge 105. The arms 104, 106 can comprise virtually any material including metal, wood, plastic, rubber, and combinations thereof. The length of each arm can vary depending upon the application. In one embodiment the second arm 106 is slightly longer than the first arm 104.

While both arms 104, 106 can pivot about the connecting hinge 105, only the second arm 106 is connected to the distal hinge 107. Thus, the second arm 106 can pivot about the distal hinge 107. The distal hinge 107 can comprise any hinge known in the art. In one embodiment the distal hinge 107 is coupled to the cabinet 101.

Turning back to FIG. 1, it can be seen that the distal hinge 107 is coupled to the cabinet 101. The distal hinge 107 can be coupled via any method known in the art. Thus, the second arm 106 can pivot about the distal hinge 107.

As noted, the right door 102b in FIG. 2 has been opened leftward. The door starts out closed. Then the user decides which side they want to open. In this instance, the user grabbed the right side of the right door 102 and pivoted the door leftward. In such a situation, the door pivots about the connecting hinge 105. The two arms 104, 106 which were adjacent become separated as the door is opened. The door rotated about the connecting hinge 105 and accordingly opens leftward. When the user desires to close the door, pressure is applied to the right side of the right door, and the door is closed.

Staying with the closed right door 102b, if the user decides to open the door in the rightward direction, the user would grasp the left side of the right door and pull outward and rightward. When this happens the door 102b pivots about the distal hinge 107. In such an embodiment the two arms 104, 106 remain adjacent to one another when the door is opened rightward because the door is pivoting about the distal hinge 107 rather than the connecting hinge 105. Accordingly, the user can open the door from either side.

The explanation for the hinges is likewise applicable to the left door. On the left door, however, the connecting hinge 105 is located on the right side of the left door 102 on the inner side. This is contrasted with the right door 102b which had the connecting hinge 105 located on the left side of the inner side. Such an example is for illustrative purposes only and should not be deemed limiting. The connecting hinge 105 can be located on whichever side is more desirable for a given situation.

In some embodiments, each door will comprise one double-hinge 109. In other embodiments, however, the door will comprise two or more than one double-hinge 109. As depicted, each door comprises two double-hinges 109. The size, weight, and dimension of the door 102 will determine the number of double-hinges 109 required. In some embodiments, and as depicted, the system further comprises a support bracket 110. The support bracket 110 is not a double-hinge, but it does help with support and stability.

In some embodiments, and as depicted, the double-hinges 109 are coupled by a connecting rod 108. A connecting rod 108 connects and couples to double-hinges to aid in support and stability. In one embodiment the connecting rod 108 comprises a substantially vertical rod which extends between the double-hinges.

In one embodiment the connecting rod 108 is secured and coupled to the cabinet door 102. In one embodiment is connecting rod 108 is stored in a recess located on the cabinet door 102. In this manner, the connecting hinge 109 is secured to the door 102. The connecting hinge 109, however, can be secured to the door 102 via any fashion using any method or device known in the art.

FIG. 3 a perspective view of double-hinges in various states in one embodiment. The top figure (1) and third figure (3) shows the double-hinge in a closed, retracted, state. In such a state the arms 104, 106 are adjacent to one another. The second figure (2) shows the double-hinge in an extended position. In such an embodiment the two arms 104, 106 have pivoted away from one another about the connecting hinge 105. In the fourth figure (4), the double-hinge is moving from a retracted to an extended position. Such an embodiment results when the cabinet door is partially open.

The cabinet doors 102 can be attached to the cabinet via any method known in the art. In some embodiments, for example, the cabinet doors 102 are attached at similar or the same location as traditional cabinet doors 102. For example, in one embodiment the cabinet doors 102 are attached via a post. Often, the middle cabinet door of a three door cabinet is attached to a vertical post which divides the cabinet and which supports the middle cabinet door. In one embodiment the double-hinge 109 connects and couples to the post. In another embodiment, however, the vertical post is removed and the double-hinge 109 or hinges are attached to the top and bottom of the cabinet opening and the post is removed. Such an embodiment provides for a substantially increased cabinet opening allowing for easy placement and removal of larger items through openings. Such items can include, but are not limited to cookware, appliances, components, and other items which are stored in cabinets.

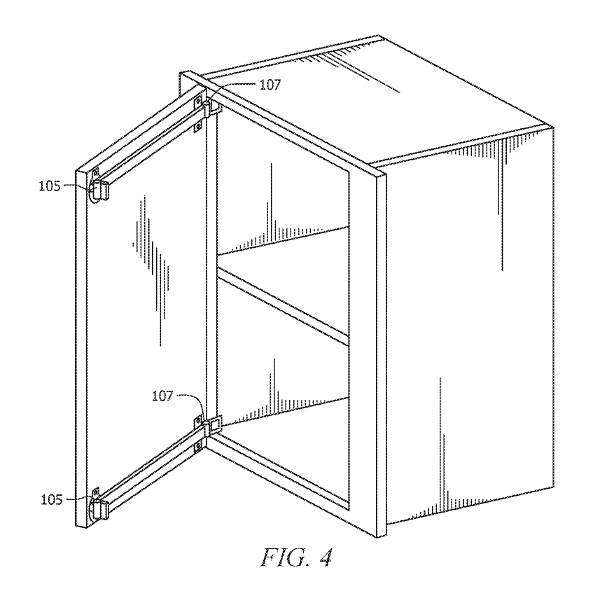

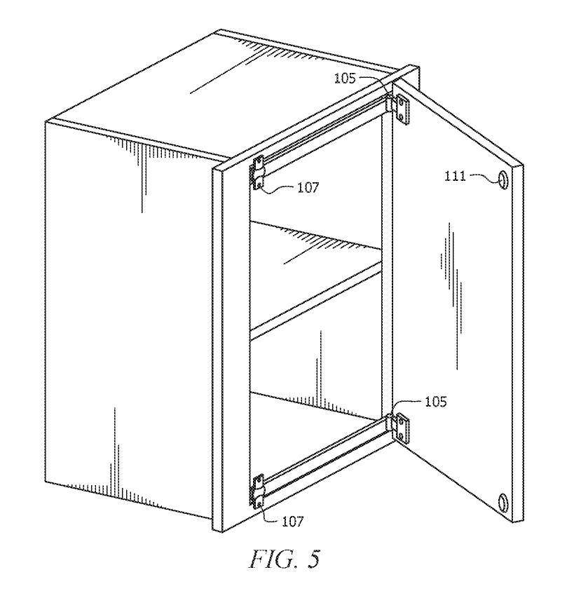

FIG. 4 is a perspective view of a double-hinge in one embodiment. FIG. 5 is a perspective view of a double-hinge in one embodiment. FIGS. 4 and 5 show the same cabinet and show the cabinet door opening from either side.

The double-hinge shown in FIGS. 4 and 5 is different in some respects from the double-hinge shown in FIGS. 1-3. As depicted, the double-hinge in FIGS. 4 and 5 comprises a single arm rather than two arms. Specifically, the upper arm in previous figures has been eliminated. Instead, each side of the cabinet door has a separate hinge which can be coupled and de-coupled to allow the door to swing as desired. In one embodiment, each connecting hinge is releasably coupled to a support hinge.

As depicted, the cabinet door comprises a recess 111. In one embodiment a hinge is stored in the recess 111. This allows the cabinet door to open and close as desired.

As noted, the system and method discussed herein allows a door to be opened in multiple directions and from multiple pivot points. If a cabinet door does not have handles, for example, and a user does not know which end pivots, the user can grab either end as both ends open. Thus, the system eliminates the situation whereby a user grabs the wrong end of the cabinet door.

Additionally, by allowing both sides of a cabinet door to open, the efficiency of the cabinet usage increases. The problems of interfering with an adjacent cabinet, dishwasher, refrigerator, etc. are eliminated because the user can simply open the door in another direction. Further, often a second person is standing in the way preventing a cabinet door from opening. Now, rather than being forced to open leftward, as an example, that user can simply open the door from the left side.

An additional benefit, in some embodiments, is that traditional hinges can be replaced with the double-hinges described herein. Thus, often, existing cabinet doors can be modified to include the double-hinge, and the accompanying benefits. As seen in FIG. 1, the double hinge 109 attaches to the door via the coupler 103. In one embodiment, the coupler 103 simply attaches to the location of the previous hinge. Thereafter, the distal hinge 107 is coupled to the cabinets. Thus, conversion of the old system to the new double-hinge system can be accomplished relatively quickly and easily.

While reference to a kitchen cabinet has been made, this is for illustrative purposes only and should not be deemed limiting. The same benefits can result from bathroom cabinets, television cabinets, storage cabinets, etc.

While the invention has been particularly shown and described with reference to a preferred embodiment, it will be understood by those skilled in the art that various changes in form and detail may be made therein without departing from the spirit and scope of the invention.

### ADDITIONAL DESCRIPTION

The following clauses are offered as further description of the disclosed invention.
Clause 1. A system comprising:

a first arm coupled to a connecting hinge;

a second arm coupled to said connecting hinge, wherein said second arm is further coupled to a distal hinge.
Clause 2. The system of any proceeding or preceding claim wherein said first arm further comprises a coupler.
Clause 3. The system of proceeding or preceding claim wherein said coupler is coupled to a cabinet door.
Clause 4. The system of proceeding or preceding claim wherein said distal hinge is coupled to a cabinet, and wherein said cabinet door can pivot about said distal end and said connecting hinge.
Clause 5. A system comprising:

a first arm coupled to a first connecting hinge;

wherein said first arm is coupled to a second connecting hinge, wherein each connecting hinge is releasably coupled to a support hinge.
Clause 6. The system of proceeding or preceding claim wherein said first arm further comprises a coupler.
Clause 7. The system of proceeding or preceding claim wherein said coupler is coupled to a cabinet door.
Clause 8. The system of proceeding or preceding claim wherein said distal hinge is coupled to a cabinet, and wherein said cabinet door can pivot about said distal end and said connecting hinge.

What is claimed is:

1. A system comprising:
a first arm coupled to a connecting hinge;
a second arm coupled to said connecting hinge, wherein said second arm is further coupled to a distal hinge.

2. The system of claim 1 wherein said first arm further comprises a coupler.

3. The system of claim 2 wherein said coupler is coupled to a cabinet door.

4. The system of claim 3 wherein said distal hinge is coupled to a cabinet, and wherein said cabinet door can pivot about said distal end and said connecting hinge.

5. A system comprising:
a first arm coupled to a first connecting hinge;
wherein said first arm is coupled to a second connecting hinge, wherein each connecting hinge is releasably coupled to a support hinge.

6. The system of claim 5 wherein said first arm further comprises a coupler.

7. The system of claim 6 wherein said coupler is coupled to a cabinet door.

8. The system of claim 5 wherein said distal hinge is coupled to a cabinet, and wherein said cabinet door can pivot about said distal end and said connecting hinge.
